(19) United States
(12) Patent Application Publication
(10) Pub. No.: US 2016/0116013 A1
(43) Pub. Date: Apr. 28, 2016

(54) COIL SPRING AND ASSOCIATED PRODUCTION METHOD

(71) Applicant: Dr. Ing. h.c. F. Porsche Aktiengesellschaft, Stuttgart (DE)

(72) Inventors: Georg von Tardy-Tuch, Unterreichenbach-Kapfenhardt (DE); Volker Peitz, Vaihingen/Riet (DE)

(21) Appl. No.: 14/924,062

(22) Filed: Oct. 27, 2015

(30) Foreign Application Priority Data
Oct. 28, 2014 (DE) 102014115619.6

(51) Int. Cl. F16F 1/366; B29C 47/02; F16F 1/36

(52) U.S. Cl. CPC F16F 1/3665; F16F 1/3605; B29C 47/021; B29K 2063/00

(57) ABSTRACT

The production of a coil spring takes place by way of a combination of two method steps, wherein the first method step consists of a twisted extrusion method and the second method step consists of a cold bending process, as in traditional spring production.

### CROSS-REFERENCE RELATED APPLICATION

This application claims priority under 35 U.S.C. §119 of German Patent Application No. 10 2014 115 619.6, filed Oct. 28, 2014, which is incorporated by reference herein in its entirety.

### BACKGROUND

The invention relates to a coil spring and also to a method for producing such a coil spring.

WO 2014/014481 A1, which is incorporated by reference herein, and WO 96/14519 A1, which is incorporated by reference herein, disclose providing a tubular core with fiber-reinforced windings, wherein the core can consist of a metal tube. Furthermore, DE 10 2006 010 543 A1, which is incorporated by reference herein, discloses a coil spring in which a nonflexible tubular core made of fiber material is provided with windings made of further fiber materials. In order to produce a coil shape, the fiber material is wound around a core.

### SUMMARY

It is an object of the invention to create a coil spring and an associated production method by way of which the coil spring is producible in a temporally rapid and continuous process, in which no special molding tools are required and it is possible to largely dispense with manual work steps.

According to aspects of the invention, this object is achieved by a coil spring, characterized by a thin-walled core tube to which fibers made of a fiber composite material are attached by winding via a supply device, said fibers covering the core tube all around, said core tube being deformable together with the attached fibers on a bending device having an integrated cold bending machine and by a method for producing the coil spring by two combined method steps, wherein the first method step comprises the application of the fibers of the fiber composite material to the core tube by means of a twisted extrusion process, and wherein, in the subsequent second method step, the composite composed of the core tube and the applied fibers of the fiber composite material is formed into the coil spring by a cold bending process in the cold bending machine of the bending device. Further advantageous features are contained in the dependent claims.

According to aspects of the invention, a coil spring and a method for producing this coil spring are intended to be created, said coil spring being producible with an accurate shape in a continuous process on a bending device having an integrated cold bending machine. This is achieved according to the invention in that fibers made of a fiber composite material are attached to a thin-walled core tube in a manner wound via a corresponding supply device, the core tube being covered all around, said core tube being deformable together with the attached fibers of the fiber composite material on the bending device or cold bending machine.

In particular, provision is made according to the invention for the bending device to comprise an external pressurized control roller, which is located opposite an internal bending roller with the spring material interposed. A feed device interacts with the bending device, a guiding feed that receives the composite composed of core tube and fibers being positioned downstream of said feed device. By way of this bending device, in conjunction with the cold bending machine and the feed device and the guiding feed, the coil spring can be produced continuously without a special molding tool. Provision is also made for the control roller to be controllable in an inclined manner in order to vary the diameter and pitch of the coil spring.

The coil spring is produced according to aspects of the invention by two combined method steps, wherein the first method step consists of continuous application of the fibers of the fiber composite material to the core tube for example by means of a twisted extrusion process, and in the subsequent second method step, the composite composed of the core tube and the applied fibers of the fiber composite material is formable into the coil spring by a cold bending process in the cold bending machine of the bending device. By way of these two combined method steps of an extrusion process and a cold bending process, a traditional spring production process, continuous production of the coil spring is achieved.

Provision is also made according to the invention for the core tube to be able to be supplied, together with applied fibers of the fiber composite material, to the bending device via the feed device and via the guiding feed, and for the control and bending rollers of the bending device to be able to bend the individual spring coils of the coil spring continuously and in succession. According to one variant of the invention, the feed device can be employed both in a manner acting on the composite of core tube and fiber winding and in a manner acting only on the core tube.

In particular, the core tube consists of a plastifiable material, such as aluminum, for example. The deformed internal core tube provides the coil spring with dimensional stability, which is required up until the curing of the fibers is complete.

According to aspects of the invention, provision is also made for the fibers of the fiber composite material of the coil spring to consist of an epoxy or thermoplastic matrix material.

If appropriate, a few counter-running rovings can also be inserted into the fibers for stabilization.

An exemplary embodiment of the invention is illustrated in the drawings and described in more detail in the following text.

### BRIEF DESCRIPTION OF THE DRAWINGS

In the drawings:

FIG. 1 shows an exemplary embodiment of a coil spring,

FIG. 2 shows a section through a coil of the coil spring on the line II-II in FIG. 1,

FIG. 3 shows a schematic view of a cold bending machine for producing the coil spring, and

FIG. 4 shows a schematic view of a complete bending device having an integrated cold bending machine and also a supply device and a guiding feed.

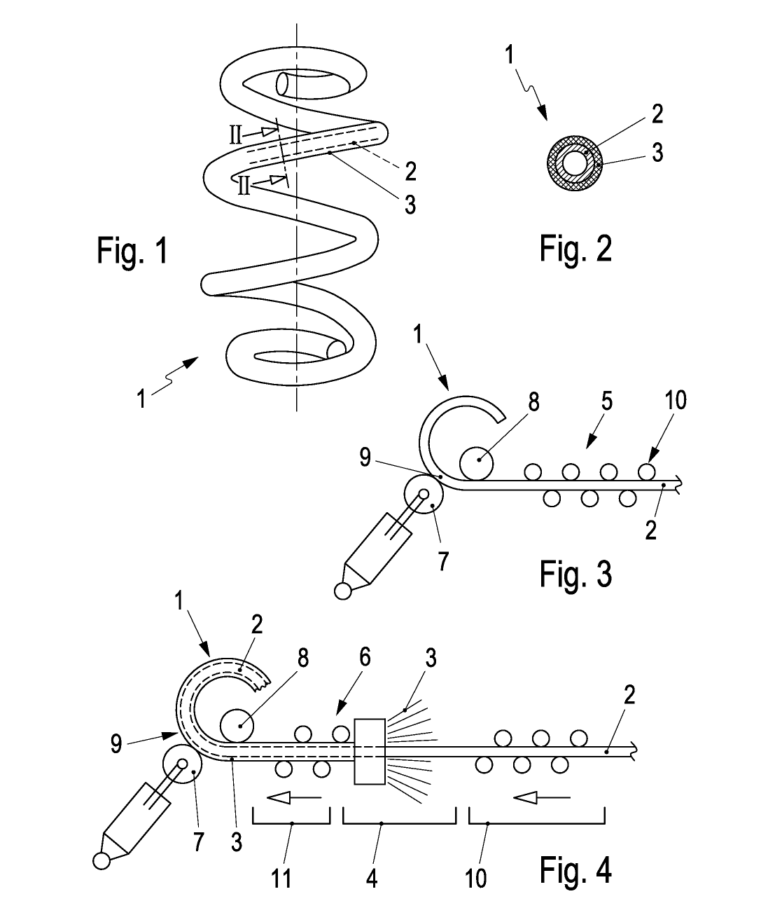

### DETAILED DESCRIPTION

A coil spring 1 comprises essentially fibers 3 attached to a thin core tube 2, said fibers consisting of a fiber composite material. The fibers 3 are attached to the core tube 2 in a manner wound via what is known as a supply device 4. The fibers 3 cover the core tube 2 all around. Via a cold bending machine 5 of the bending device 6, the composite composed of the core tube 2 and the fibers 3 is jointly deformed.

The bending device 6 of the cold bending machine 5 comprises an external, adjustable pressurized control roller 7, which is located opposite an internal bending roller 8 with the spring material 9 interposed.

The bending device 6 has on its front side a feed device 10. Furthermore, arranged downstream of the supply device 4 is a guiding feed 11 that receives the core tube 2 together with applied fibers 3, said guiding feed 11 supplying the composite composed of the core tube 2 and fibers 3 directly to the control roller 7.

The method for producing the coil spring 1 is carried out by two combined method steps, wherein the first method step consists of continuous application of the fibers 7 of the fiber composite material directly to the core tube 2 by means of a for example twisted extrusion process. In the subsequent second method step, the composite composed of the core tube 2 and the applied fibers 3 of the fiber composite material is formed into the coil spring 1 by a cold bending process in the cold bending machine 5 of the bending device 6.

The core tube 2 is supplied, together with the applied fibers 3 of the fiber composite material, to the bending device 6 via the front feed device 10 and via the guiding feed 11, wherein the control and bending rollers 7, 8 of the cold bending machine of the bending device 6 produce the individual spring coils continuously and in succession.

The front feed device 10 can act both on the composite of the core tube 2 and connected fibers 3, and also only on the core tube 2.

The core tube 2 consists preferably of a plastifiable material, such as aluminum, for example.

The fibers 3 of the fiber composite material of the coil spring 1 consist preferably of an epoxy or thermoplastic matrix material.

1. A coil spring, comprising a thin-walled core tube to which fibers made of a fiber composite material are attached by winding via a supply device, said fibers covering the core tube all around, said core tube being deformable together with the attached fibers on a bending device having an integrated cold bending machine.

2. The coil spring as claimed in claim 1, wherein the bending device comprises an external pressurized control roller, which is located opposite an internal bending roller with the spring material interposed, and a feed device interacts with the bending device, a guiding feed that receives the composite composed of core tube and fibers being positioned downstream of said feed device.

3. A method for producing the coil spring of claim 1, comprising the steps of applying the fibers of the fiber composite material to the core tube by means of a twisted extrusion process, and subsequently forming the composite comprising of the core tube and the applied fibers of the fiber composite material into the coil spring by a cold bending process in the cold bending machine of the bending device.

4. The method of claim 3, wherein the core tube is able to be supplied, together with the applied fibers of the fiber composite material, continuously to the bending device via the feed device and via the guiding feed, and the control and bending rollers of the bending device are able to bend the individual spring coils of the coil spring continuously and in succession.

5. The method of claim 3, wherein the feed device acts either on the composite of core tube and fibers or only on the core tube.

6. The method of claim 3, wherein the core tube comprises a plastifiable material.

7. The method of claim 3, wherein the fibers of the fiber composite material of the coil spring comprise an epoxy or thermoplastic matrix material.

8. The method of claim 4, wherein the feed device acts either on the composite of core tube and fibers or only on the core tube.

9. The method of claim 4, wherein the core tube comprises a plastifiable material.

10. The method of claim 5, wherein the core tube comprises a plastifiable material.

11. The method of claim 4, wherein the fibers of the fiber composite material of the coil spring comprise an epoxy or thermoplastic matrix material.

12. The method of claim 5, wherein the fibers of the fiber composite material of the coil spring comprises an epoxy or thermoplastic matrix material.

13. The method of claim 6, wherein the fibers of the fiber composite material of the coil spring comprises an epoxy or thermoplastic matrix material.
